(19) United States
(12) Patent Application Publication
(10) Pub. No.: US 2021/0087041 A1
(43) Pub. Date: Mar. 25, 2021

(54) Portable Beverage Service and Dispensing Cart

(71) Applicants: Lev Volftsun, Sterling, VA (US); Paras Goda, Sterling, VA (US)

(72) Inventors: Lev Volftsun, Sterling, VA (US); Paras Goda, Sterling, VA (US)

(73) Assignee: Sestra Systems, Inc., Sterling, VA (US)

(21) Appl. No.: 16/933,147

(22) Filed: Jul. 20, 2020

Related U.S. Application Data
(63) Continuation-in-part of application No. 16/744,263, filed on Jan. 16, 2020.
Application No. 16/744,263 is a continuation-in-part of application No. 16/708,788, filed on Dec. 10, 2019.
Application No. 16/708,788 is a continuation-in-part of application No. 16/503,681, filed on Jul. 5, 2019.
Application No. 16/503,681 is a continuation-in-part of application No. 15/869,028, filed on Jan. 11, 2018, now Pat. No. 10,294,093.
Application No. 15/869,028 is a continuation-in-part of application No. 15/424,478, filed on Feb. 3, 2017, now Pat. No. 10,167,183.
Application No. 15/424,478 is a continuation-in-part of application No. 15/332,117, filed on Oct. 24, 2016, now Pat. No. 10,294,092.
Application No. 15/332,117 is a continuation-in-part of application No. 14/686,820, filed on Apr. 15, 2015, now Pat. No. 10,125,002.
Application No. 14/686,820 is a continuation-in-part of application No. 14/686,597, filed on Apr. 14, 2015.
(60) Provisional application No. 63/029,585, filed on May 25, 2020.
(60) Provisional application No. 63/016,379, filed on Apr. 28, 2020.
(60) Provisional application No. 63/016,339, filed on Apr. 28, 2020.
(60) Provisional application No. 63/016,315, filed on Apr. 28, 2020.
(60) Provisional application No. 63/016,311, filed on Apr. 28, 2020.
(60) Provisional application No. 62/949,141, filed on Dec. 17, 2019.
(60) Provisional application No. 62/023,899, filed on Jul. 13, 2014.

(30) Foreign Application Priority Data
Apr. 13, 2016 (US) PCT/US16/27175

(51) Int. Cl. B67D 1/00; B67D 1/08; B67D 1/14; B67D 1/12

(52) U.S. Cl. CPC B67D 1/0041; B67D 1/0891; B67D 2001/1483; B67D 1/1405; B67D 1/1281; B67D 1/0888

(57) ABSTRACT

A beverage dispensing cart is provided for the portable and independent controlled dispensing of keg beverages. Delivery of beer and/or wine on tap is provided from a portable, battery powered beverage service and dispensing cart. One or more bulk beverage keg containers are stored within temperature-controlled compartments, each dispensed from a separate tap tower. Each tap tower comprises at least one individually operable touchless tap for and in operational communication with an automated Beverage Dispensing System for an automated and controlled dispensing of a metered volume of beverage from the bulk beverage keg. A plurality of casters are attached to a lower surface of the cabinet in a manner to allow the portable beverage service and dispensing cart to be portably transported. Use of the portable beverage service and dispensing cart enable the use of keg beverages in a venue in a portable manner.

### BACKGROUND OF THE INVENTION

### 1. Field of the Invention

The present invention relates to a beverage services for bar, restaurants or events and, more particularly, to the device, system and method for enabling the use of keg beverages, such as beers and/or wines in such venues in a portable manner.

### 2. Description of the Related Art

Wine is typically stored in sealed bottles which prevent the deterioration of the wine caused by extended contact with ambient air. The bottle that has become a standard unit of volume to describe sales in the wine industry measures 750 milliliters (26 imp. fl. oz.; 25 US fl. oz.). Wine bottles are traditionally sealed with cork, but screw-top caps are becoming popular, and there are several other methods used to seal a bottle.

While perfectly adequate for dispensing wine for a meal or a small gathering, in the hospitality industry, the handling, opening, and dispensing of numerous glass bottles in hospitality settings or during events, as well as the disposal of the empty bottles, can create unnecessary waste in efficiency and ecology. The service and dispensing of a high volume of wine in 750 ml increments, as well as the disposal of a high number of glass bottles, create dispensing, service and handling bottlenecks

“Wine on Tap” is a distribution method for wine that has been developed for such high volume dispensing and service applications. Instead of distributing via the bottle, wine is housed in stainless steel kegs. After the barreling stage, the wine is transferred into stainless steel kegs holding about 26 bottles of wine each (or 130 glasses). It is pushed through the keg by gases such as nitrogen or argon, further providing a blanket over the wine and protecting it from oxidation. Also recently developed are similar lightweight one-way kegs known as the KeyKeg® by Eurokeg B. V. of the Netherlands. A KeyKeg® is a cylindrical 30-litre keg in which the container's two walls work together dynamically for dispensing wines in a manner that can keep for weeks after initial broaching of the container.

Wine on tap utilizes cost savings at all levels, from the manufacturer, retailer and consumer. Traditionally, wine retailers have served wine by the glass by opening and resealing individual bottles. With wine on tap, bottle, cork, and carton costs are eliminated. Costs of waste from throwing away oxidized wine are also decreased and fresher un-oxidized wine is delivered to the consumer. Transport costs are significantly reduced as well, as the same amount of wine weighs significantly more in bottles than in a keg.

The implementation of an infrastructure to deliver wine on tap can be problematic. Traditionally, both beer and carbonate beverages already have a “tap” delivery infrastructure in most hospitality settings. However, with the exception of newly constructed facilities, the placement of the necessary steel kegs, distribution gases, chilling equipment and delivery taps will inevitably require retrofitting of available space.

Some methods and devices are known that incorporate various mechanisms for providing the distribution and delivery of “wine on tap” for larger venues. For example:

U.S. Pat. No. 10,167,183, issued in the name of Volftsun et al, teaches a system and method for beverage dispensing of bulk keg wine having, in combination: integrated temperature control; pressure monitoring; automated purging; and integrated point of sale data acquisition for determining inventory usage statistics for each keg of wine dispensed. The system provides for precise measurement of each portion. Control algorithms for adapting system operation provide anticipated travel time and distances, and anticipated dispensed volumes and volumetric flow rates to allow for precise control of selected pour volumes. A relationship is calibrated among applied pressures, piston delay time, and dispensed per push volume to achieve higher control accuracy between a maximum and minimum system pressure ranges.

U.S. Pat. No. 10,125,002, issued in the name of Volftsun, discloses a related system and method for the automated dispensing of bulk keg wine having, in combination: integrated temperature control; pressure monitoring; automated purging; and integrated points of sale data acquisition for determining inventory usage statistics for each keg of wine dispensed. The system provides for precise measurement of each portion. An error alarm system warns an operator about beverage tank low level. A system for forcing the flashing of poor quality beverages. Recording of all delivery process events allows for operator or management review and control.

U.S. Pat. No. 10,294,093, issued in the name of Volftsun et al., discloses a touchless tap for beverage dispensing is provided that incorporates a spring and ball check valve within a spigot housing. The spigot housing as a male threaded end for connection to a beverage dispensing line. Between the beverage connection and the check valve is a flow control valve having a detachable control mechanism. A system operator can use the control mechanism to calibrate fluid flow. The control mechanism is further fastened or keyed to allow for removal after modifying system flow parameters. A tap handle extension is further provided that can be threadingly affixed to the spigot housing. The tap handle extension specifically does not control operational parameters, which are intended to be initiated through pushbutton control of a pour control system.

U.S. Pat. No. 9,926,181, issued in the name of Volftsun et al., also teaches a related touchless tap for beverage dispensing that incorporates a spring and ball check valve within a spigot housing. The spigot housing as a male threaded end for connection to a beverage dispensing line. Between the beverage connection and the check valve is a flow control valve having a detachable control mechanism. A system operator can use the control mechanism to calibrate fluid flow. The control mechanism is further fastened or keyed to allow for removal after modifying system flow parameters. A tap handle extension is further provided that can be threadingly affixed to the spigot housing. The tap handle extension specifically does not control operational parameters, which are intended to be initiated through touchscreen or pushbutton control of a pour control system.

While the beverage dispensing systems and touchless taps of these references may be incorporated into this invention in combination, other elements are different enough as to make the combination distinguished over the inventors' own prior art.

Consequently, a need has been felt for providing an apparatus and method for enabling the use of keg beers and/or wines in a portable manner

### SUMMARY OF THE INVENTION

It is thus an object of the present invention to provide a device, system and method for enabling the use of keg beer and/or wine.

It is a feature of the present invention to deliver beer and wine on tap in an automated and portable manner.

Briefly described according the preferred embodiment of the present invention, an implementation of an infrastructure is provided to deliver wine on tap to provide for the storage of at least one, and preferably a plurality of multi-bottle kegs of wine (or, to deliver wine on tap and beer in a common service and dispensing cart). A portable beverage service and dispensing cart includes a cabinet enclosing an interior volume and supporting an upper counter top. The cabinet is formed of a structural frame encasing a number of interior volumes forming separate temperature-controlled compartments. A door access the interior volume. An upper counter top supporting a tap tower and is configured to provide a beverage area. One or more bulk beverage keg containers are stored within each temperature-controlled compartment and in operative communication with a separate tap tower. Each tap tower comprises at least one individually operable touchless tap for and in operational communication with an automated Beverage Dispensing System for an automated and controlled dispensing of a metered volume of beverage from the bulk beverage keg. A plurality of casters are attached to a lower surface of the cabinet in a manner to allow the portable beverage service and dispensing cart to be portably transported. A beverage control system control beverage to the touchless tap supplied under pressure from within the keg. One or a plurality of rechargeable batteries supported on or in the cabinet controls the beverage control system and touchless tap.

Use of the portable beverage service and dispensing carts enable the use of keg wines in a venue in a portable manner. Deployed in a portable, relocatable, and automated and controlled manner, dispensing from the keg beverages is controlled through the touchless tap in a remote, automated, controlled and recorded manner while monitoring the dispensing of beer and/or wine. Documentation and reporting of function and output may be delivered to a remote display system.

Advantages of the present invention includes providing a beverage service and dispensing cart for the efficient storage, placement, operation and access to the necessary steel kegs, distribution gases, chilling equipment and delivery taps required for the use of wine on tap delivery in hospitality type venues.

It is a further advantage of the present invention is to provide a wine dispenser that is compact and occupies a small footprint while storing the equivalent of at least two cases of wine.

It is a further advantage of the present invention is to provide such a wine dispenser that portable to be easily transported from one location to another.

Yet another advantage of the present invention is to provide a wine dispenser that can speed up the serving of wine.

Still another advantage of the present invention is to provide a wine dispenser that can supply wine at proper serving temperature.

Further objects, features, elements and advantages of the present invention will become readily apparent from the following detailed description of the preferred embodiment when considered with the attached drawings and the appended claims.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front isometric view of a portable beverage service and dispensing cart according to a preferred embodiment of the present invention;

FIG. 2 is a rear isometric view thereof;

FIG. 3a through FIG. 3d are front right, front left, rear right and rear left renderings thereof, respectively;

FIG. 4 is a front elevational view thereof;

FIG. 5 is a rear elevational view thereof;

FIG. 6 is a left side elevational view thereof;

FIG. 7 is a right side elevational view thereof;

FIG. 8 is a top plan view thereof;

FIG. 9 is a top internal plan arrangement thereof;

FIG. 10 is an electrical schematic for use therewith;

FIG. 11 through FIG. 25 are front perspective renderings showing alternate configurations of portable beverage service and dispensing carts incorporation the features and elements of the preferred embodiment of the present invention in various form factor permutations;

FIG. 26 is a schematic view of a portable beverage service and dispensing cart according to a preferred embodiment of the present invention shown in operation in a hospitality venue;

FIG. 27 is a specification sheets for a battery operated cart in a first alternate variation for in-line chilling for wine; and

FIG. 28 is a specification sheets for a battery operated cart in a second alternate variation for incorporating a Perlick-style commercial refrigerator model DDS36 fridge for beer and other beverages including but not limited to prosecco, cold brew coffee, nitro coffee as well as condiments and hand sanitizer, spray perfume/cologne etc.

### DESCRIPTION OF THE PREFERRED EMBODIMENTS

The best mode for carrying out the invention is presented in terms of its preferred embodiment, herein depicted within the Figures. It should be understood that the legal scope of the description is defined by the words of the claims set forth at the end of this patent and that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

The best mode for carrying out the invention is presented in terms of its preferred embodiment, herein depicted within the Figures.

### 1. Detailed Description of the Figures

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation.

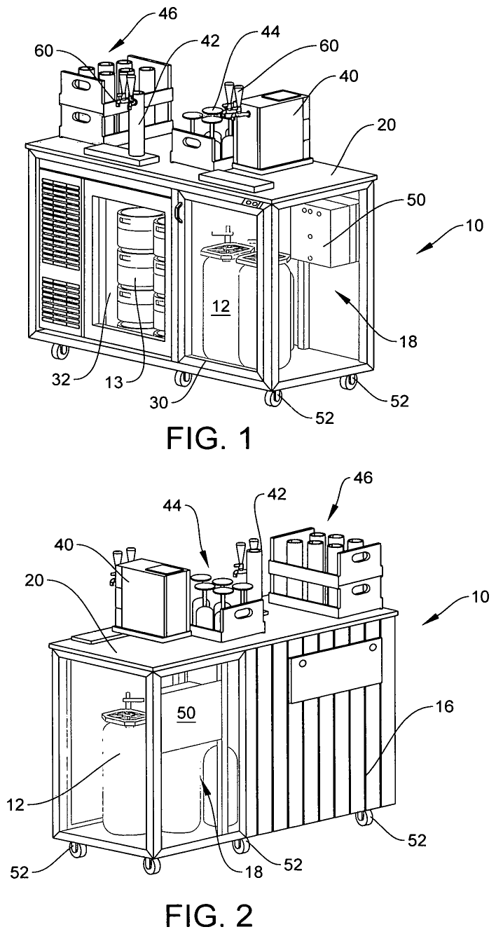

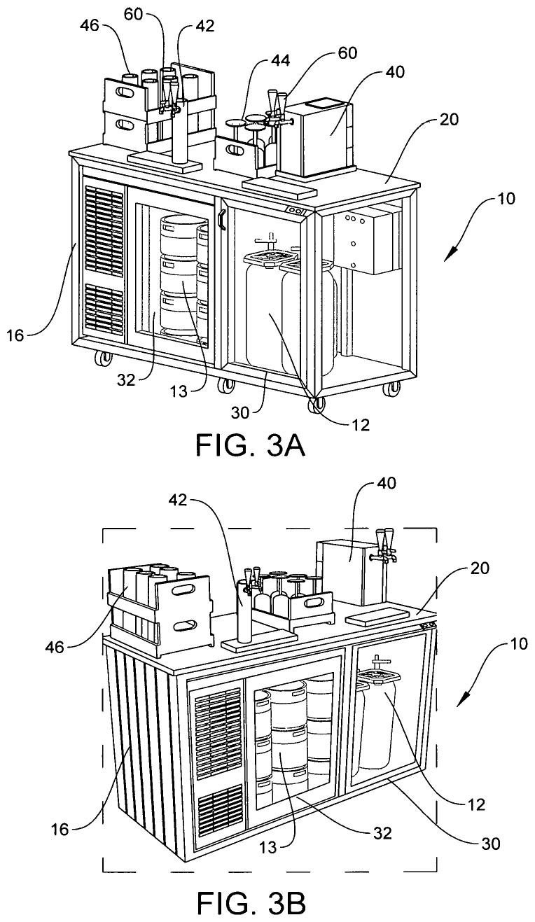

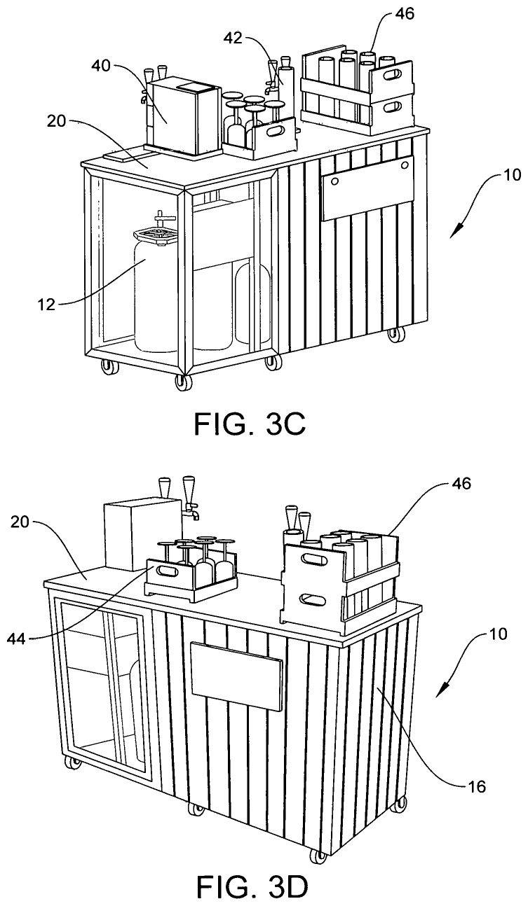

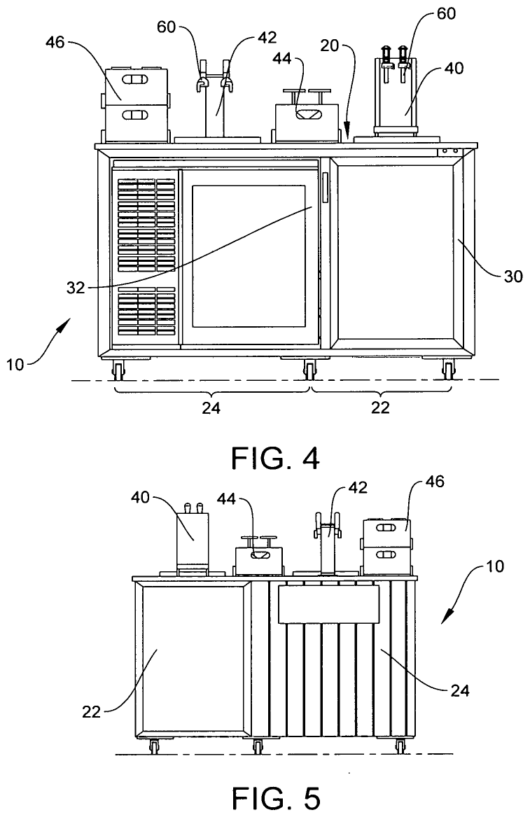

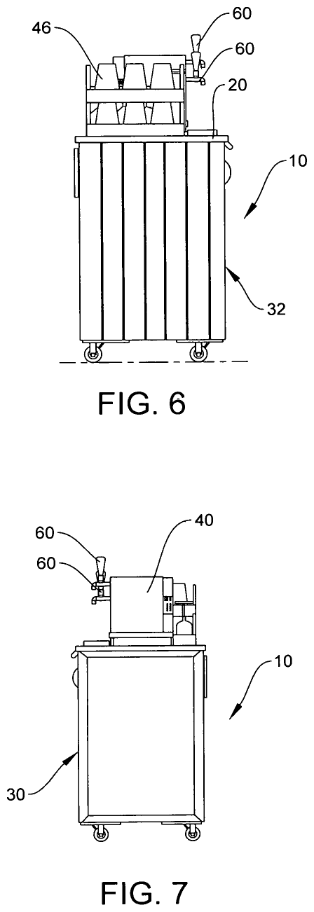

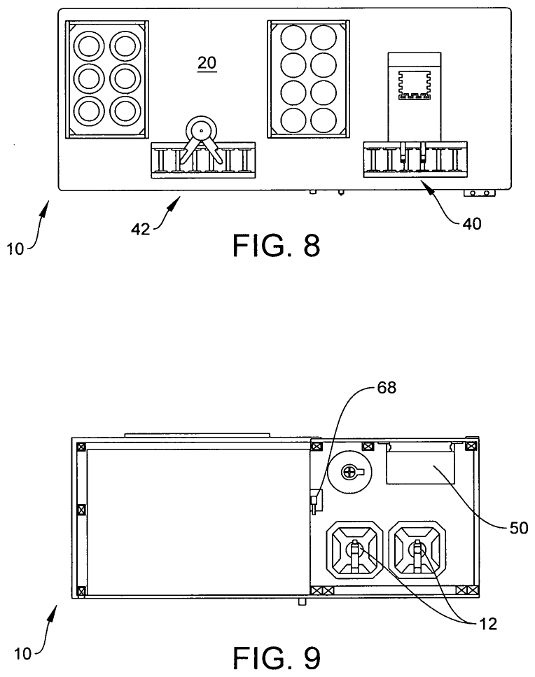

Referring now to FIG. 1-9, a beverage dispensing cart, generally noted as 10, is shown according to the preferred embodiment of the present invention for the storage of a plurality of multi-bottle kegs 12 of wine. It is anticipated the such multi-bottle kegs 12 may be those one-way kegs known as the KeyKeg® as provided by Eurokeg B. V. of the Netherlands, or other similar system. Such a KeyKeg® is a cylindrical 30-litre keg in which the container's two walls work together dynamically for dispensing beer and wine or a number of wines. However, it should be apparent to a person having ordinary skill in art, in light of the teachings and descriptions of the present invention, that other types of wine kegs, such as with stainless steel kegs, and further other types of keg beverage, such as stainless steel beer kegs 13, may similarly be included.

Stainless steel kegs, when depleted, are routinely returned for cleaning, sterilizing and reuse. Such kegs are made from stainless steel, and are generally 20 liter/5.17 gallon kegs with American Sanke “D” fitting having a 23⅜″ height and 9″ diameter. One way kegs generally recyclable, food grade PET plastic that used once prior to being recycled. As with stainless steel kegs, one way kegs are 20 liter/5.17 gallon kegs with American Sanke “D” fitting, 23⅜″ height and 9″ diameter.

The beverage cart 10 may include a cabinet 16 enclosing an interior volume 18 and supporting an upper counter top 20. The cabinet 16 may be formed of a structural frame that may be formed of welded mild steel tubes. The interior volume 18 may include a first temperature-controlled compartment 22 and a second temperature-controller compartment 24. Compartments 22 and 24 could be arranged lateral to one another (side-by-side). The temperature inside each compartment 22, 24 may be controlled independently appropriate to multiple different beverage types with each being able to be delivered at an optimum service temperature. By way of additional detail, for example, when it comes to serving temperature it is commonly accepted that a wine has an appropriate service temperature: if too warm the wine's alcohol will be emphasized, leaving it flat and flabby; and, if too cold the aromas and flavors will be muted and, for reds, the tannins may seem harsh and astringent. General guidelines for appropriate service temperatures include: Light dry white wines, rosés, and sparkling wines being served at between 40° to 50° F.; Full-bodied white wines and light, fruity reds being serve at between 50° to 60° F.; Full-bodied red wines and Ports being served at 60° to 65° F. Further still, beers may be considered best if served either warmer or colder (depending upon type and cultural preference) and mixed cocktails are generally considered best if served colder. In order to accommodate such a variation in optimum beverage temperature, the service temperatures within each compartment may be varied to accommodate such differences.

Each compartment 22, 24 may include a door 30, 32 respectively to provide access to and egress from each respective compartment 22, 24. Each door 30, 32 may include a transparent window to allow viewing of the interior of the compartment. A light or the like (not shown) may also be provided inside each compartment 22, 24 to illuminate the interior thereof and a lock (not shown) may be provided to lock each door 30, 32.

The countertop 20 may support one or more tap towers. The countertop 20 may support a first tap tower 40 in communication with the first compartment 22 and a second tap tower 42 in communication with the second compartment 24. Each tap tower 40, 42 may be in communication with the respective bulk beverage containers 12, 13 respectively for dispensing in a manner described in greater detail below. As shown and envisioned in one design configuration, a multi beverage wine tap tower 40 is in communication with and dispenses from multiple wine kegs 12 at a first temperature from within the first compartment 18. And, a single or multiple beverage beer tap tower 42 is in communication with and dispenses from a single or multiple beer kegs 13 at a second temperature from within the second compartment 20. The countertop 20 may further be sized and configured such as to provide additional beverage staging such as, for example, the storage of beverage glasses such as wine glasses 44 and/or beer glasses 46.

Each tap tower 40,42 may include one or a plurality of individually operable touchless tap 60 for and in operational communication with an automated Beverage Dispensing System 50 of the Related Art. Further, the touchless tap 60 may also be functionally equivalent to the touchless tap of the Related Art that includes a spigot housing, a check valve mechanism, a discharge spout, and a flow control adjustment mechanism. The spigot housing may be provided in any form factor that emulates existing tap spigots. The housing should include a threaded connection to allow for connection with tap tower 40, 42 in respective fluid communication with those Beverage Dispensing System 50 of the type described, taught or anticipated by or within those references from which the present invention claims priority benefit or their equivalents. A tap handle extension may further provided that can be threadingly affixed to the spigot housing. The tap handle extension specifically does not control operational parameters but rather provide only a visual indicia of its purpose, with actual operation intended to be initiated through pushbutton or other type of remotely operated control of a pour control system (not shown). While the tap handle extension may provide an overall form factor similar to an otherwise conventional tap spigot and can be used for affixing branded or designed handles, with no manual opening or closing can be initiated from the tap handle extension.

The check valve mechanism may be provided between the flow control adjustment mechanism and the discharge spout and may include a spring and ball construction for providing opening or closing at a desired system pressure. The check valve mechanism may be adjustable to provide for differences is opening or closing pressures. Between the beverage connection and the check valve housing is a flow control adjustment mechanism. The flow control adjustment mechanism may be used as a control mechanism to calibrate fluid flow through the discharge spout 60.

According to a functionally equivalent aspect of the present invention, the flow control valve may also be provided in the form of a solenoid control valve, or a pneumatic control valve. It has been determined that the use of a solenoid control valve is not operationally compatible when used in conjunction with an automated beverage control system for dispensing of beverages having carbonation, such as beer or sparkling wines, in that the configuration of such valves appear to facilitate a turbulence that makes a dispensed beverage discharge to be commercially unacceptable. As such, the use of solenoid control valves is envisioned to be limited for use with the dispensing of noncarbonated beverages, such as non-sparkling wines, mixed alcoholic or non-alcoholic beverages, flavored waters, energy drinks, or similar or equivalent beverages.

Alternately, the use of a pneumatic control valve variant appears to be acceptable for the automated dispensing of most beverage options. It has been determined that the use of a pneumatic control valves in such an operation would further benefit by using the same pneumatic pressure source that is generally provided to supply the beverage urging force for automated beverage control systems. In any variant, the control valve may be positioned within said discharge spout in lieu of the spring activated check valve, or may be positioned within the spigot housing in the fluid line prior to the check valve mechanism.

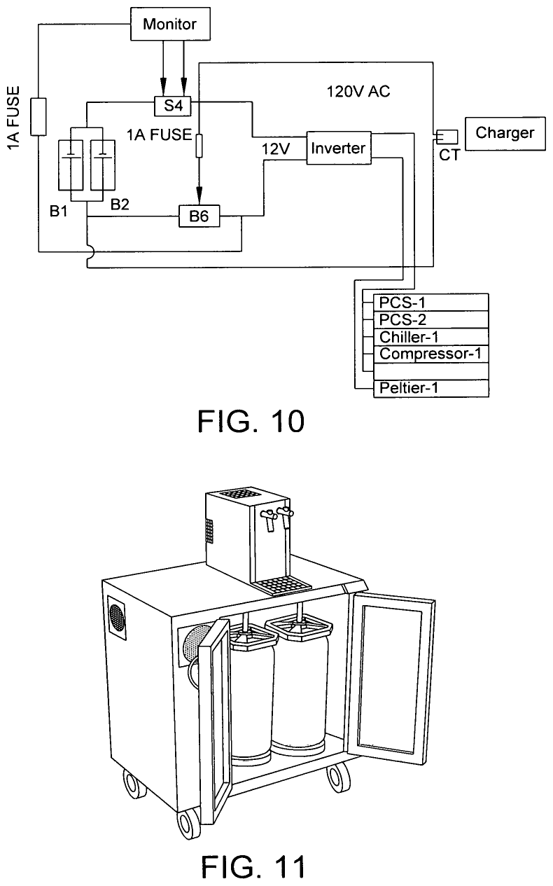

In addition to having separately controlled temperature zones, within each respective compartment 22, 24 is intended to be incorporated a separate beverage control system 50. Each beverage, whether beer or wine is communicated to each respective tap 60 being supplied under pressure from within the keg. As shown in conjunction with FIG. 10, each beverage control system is thereby electrically operated via a battery 68. The battery may be an NSB 92FT Red Battery® as provided by NorthStar Battery Company of Springfield, Mo. or an operative functional equivalent.

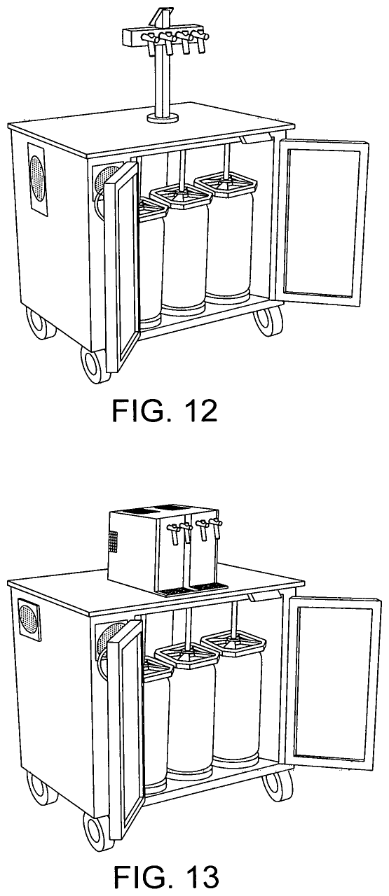

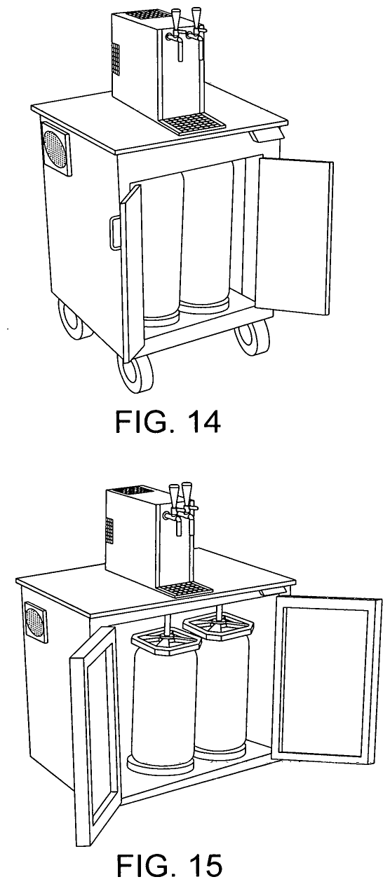

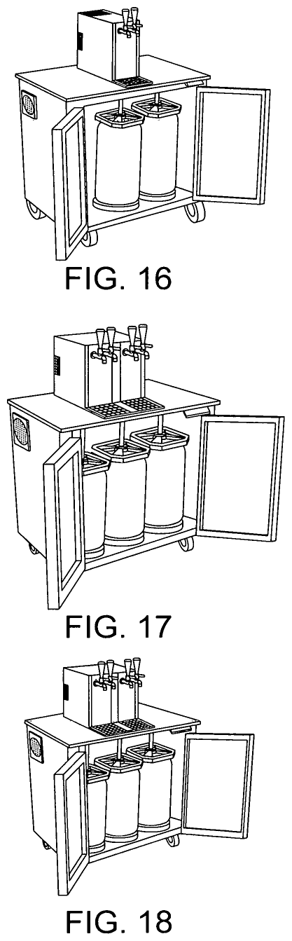

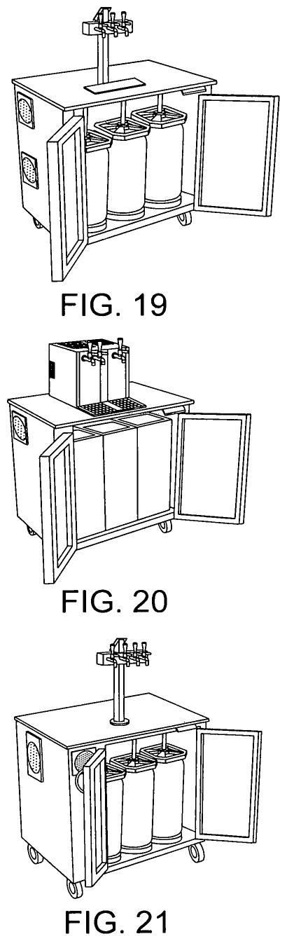

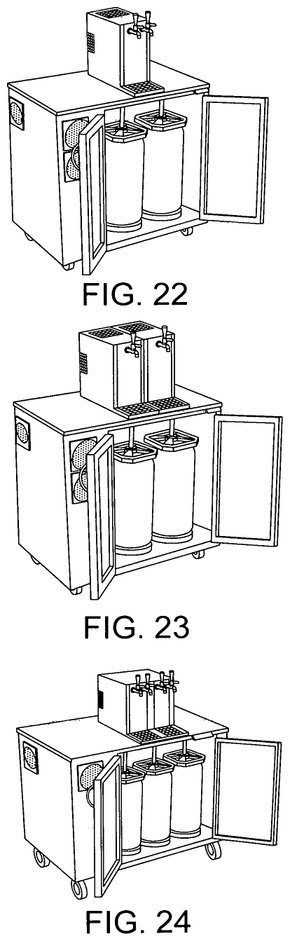

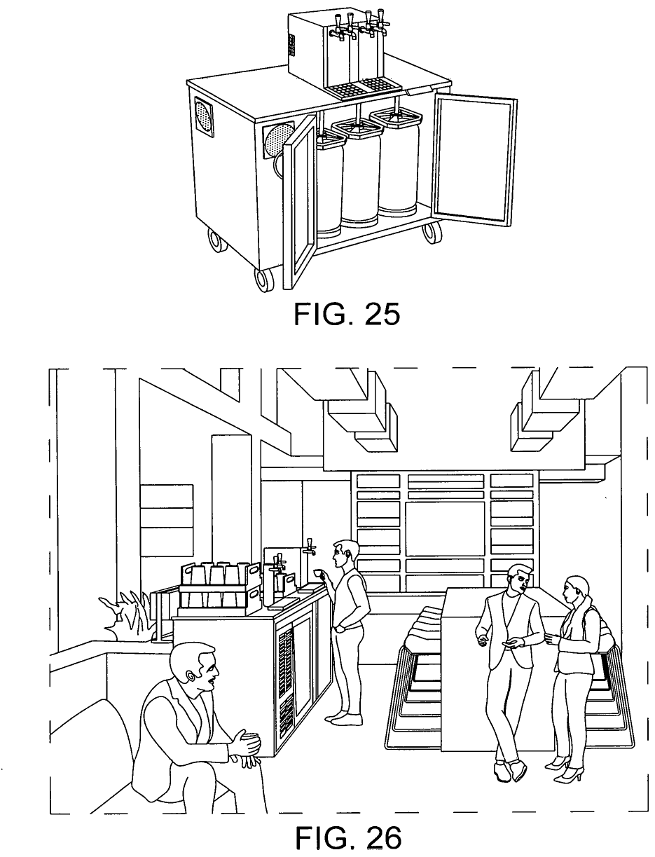

Referring now in conjunction with FIG. 11 through 25, the overall size and dimensions of the platform 10 is shown in various permutations of size, shape, number of compartments, etc. It is considered one feature and function of the present invention to provide a beverage dispensing cart 10 that can be readily adapted to various overall sizes and dimensions.

In any permutation or configuration, any beverage cart 10 may have a plurality of casters 52 or the like installed on or otherwise attached to its base, whereby the beverage dispenser 10 may be portably transported between locations, including when the unit 10 is filled with beverage kegs. It has been found locking swivel type casters may be preferred.

The beverage cart may be adapted to use Absorbent Glass Mat (AGM) style batteries which are sealed and spill proof. Selected for it safety, such batteries provide vibration resistance from disturbances while mobilizing the cart on uneven terrain. Wide range of operational temperature (−40 C to 65 C) allows AMG style of batteries to withstand outdoor season cycles compared to typical lead acid batteries. This combined with the removal of an electrical cord for power adds safety and efficiently to easily maneuver the cart to optimal sales locations throughout the duration of a venue's event, increasing value and flexibility as conditions change at an event.

The battery operated cart is combined with a shunt resistor from Bogart industries (Model SH-500-50) and the Trimetric TM-2030 battery monitor to allow for end user to check and verity status of health of system, including battery voltage, current amperage draw as well as other standard metrics as seen by others skilled in the art. Audible alarms are present for user convenience of low battery, and protection from overcurrent/overvoltage conditions to enhance the safety to the end user. In combination with Battery Guard BG Series, this system is sized to allow configurations seen in FIGS. 27 and 28 of one or more chilling units, countertop 40 or large refrigerator such as Perlick DDS36 or equivilent. Provided with a 3000 W inverter, X3000 Freedom X Inverter 12 VDC, and with wires guaged according to FIG. 10, system is capable of supporting large inductive loads and inrush current of 6000 W.

System is designed to be modular with 12V batteries to allow a average 8 hour consumer run cycle or scale, with four batteries, or scale up or down in 1 battery increments to allow the proper balance of size, weight and longevity.

System design is optimized for minimal cable length to reduce restive loses at high current (60 A or more) and allow for ease free maintenance by introducing Anderson SB series and PowerPole series interconnects, rated at appropriate size and capacity per FIG. 10.

### 2. Operation of the Preferred Embodiment

In operation, the portable beverage service and dispensing cart 10 of the present invention may be provided as a portable, relocatable, self operating Beverage Dispensing System, adapted from teachings within the Related Art. The cart 10 may be maintained in a portable, self-sufficient manner to allow the cart 10 to be positioned remotely in a selected location and thereafter operated during an event on battery power. As derived from TABLE 1 and would be apparent to one having ordinary skill in the relevant art, in light of the present teachings, exemplary power calculation show that the cart 10 may operate in a free-standing manner for a reasonable commercial period such as 8-10 hours. As further shown in conjunction with TABLE 2, it has been found that a plurality of chiller units may be provided per each separate compartment 22, 24 in order to maintain a preferred beverage temperature via battery power and independent control. If required, the use of more than three (3) chiller units may be operationally configured with a surge protector. The surge protector may include the Battery Guard BG Series provided from Samlex America® of Burnaby, BC Canada or similar or functional equivalent.

Intended to provide a portable, relocatable, self operating Beverage Dispensing System, the present invention may be deployed in a variety of existing hospitality venues. Using rechargeable battery operation, the System 50 may control dispensing of keg beverages (i.e., beer, wine, etc.) through the touchless tap 60 in a remote, automated, controlled and recorded manner. After being placed in service for the controlled, monitored dispensing of beer and/or wine, the cart 10 may then be retired such that the battery may be recharged in preparation for subsequent use. Such dispensing of beer or wine in an automated manner from a dispensing cart 10 is efficient for storage, placement, operation and access of the necessary steel kegs, distribution gases, chilling equipment and delivery taps required for the use of wine on tap delivery in hospitality type venues. Further, the wine dispenser 10 is compact and occupies a small footprint while storing the equivalent of multiple cases of wine while portable and easily transported from one location to another.

The foregoing descriptions of specific embodiments of the present invention are presented for purposes of illustration and description. The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein, but is to be accorded the full scope consistent with the language claims and to encompass all legal equivalents. Notwithstanding, none of the claims are intended to embrace subject matter that fails to satisfy the requirement of 35 U.S.C. § 101, 102, or 103, nor should they be interpreted in such a way. Any unintended embracement of such subject matter is hereby disclaimed. They are not intended to be exhaustive nor to limit the invention to precise forms disclosed and, obviously, many modifications and variations are possible in light of the above teaching. The embodiments are chosen and described in order to best explain principles of the invention and its practical application, to thereby enable others skilled in the art to best utilize the invention and its various embodiments with various modifications as are suited to the particular use contemplated. It is intended that a scope of the invention be defined broadly by the Drawings and Specification appended hereto and to their equivalents. Therefore, the scope of the invention is in no way to be limited only by any adverse inference under the rulings of Warner-Jenkinson Company, v. Hilton Davis Chemical, 520 US 17 (1997) or Festo Corp. v. Shoketsu Kinzoku Kogyo Kabushiki Co., 535 U.S. 722 (2002), or other similar caselaw or subsequent precedent should not be made if any future claims are added or amended subsequent to this patent application.

What is claimed is:

1. A portable beverage service and dispensing cart for the automated and controlled delivery of bulk beer and/or wine and comprising:
a cabinet enclosing an interior volume and supporting an upper counter top, said cabinet formed of a structural frame encasing an interior volume forming at least a first temperature-controlled compartment controlled to a first temperature appropriate to a first service temperature for a first beverage;
a first door providing access to and egress from the interior volume;
the upper counter top supporting a first tap tower in communication with the first compartment, said upper counter top further configured to provide a beverage area;
a first bulk beverage keg containers stored within the first temperature controlled compartment and in operative communication with the first tap tower;
said first tap tower comprising at least one individually operable touchless tap for and in operational communication with a first automated Beverage Dispensing System for an automated and controlled dispensing of a metered volume of beverage from the first bulk beverage keg;
a plurality of casters attached to a lower surface of the cabinet in a manner to allow the portable beverage service and dispensing cart to be portably transported;
the first beverage control system for controlling communication of the beverage to the first touchless tap supplied under pressure from within the first keg; and
a rechargeable battery supported on or in the cabinet in operational electrical control of the first beverage control system and first touchless tap.

2. The portable beverage service and dispensing cart of claim 1, wherein said first touchless tap is pneumatically controlled using a same pneumatic pressure source that is provided to supply a beverage urging force to the first bulk beverage keg.

3. The portable beverage service and dispensing cart of claim 1, wherein said first touchless tap comprises a spring activated check valve positioned within a discharge spout, wherein said check valve is within a spigot housing in the fluid line prior to the discharge spout.

4. The portable beverage service and dispensing cart for the automated and controlled delivery of beer and/or wine of claim 1, wherein:
said cabinet encasing an interior volume further forming at least a second temperature controlled compartment controlled to a second temperature appropriate to a second service temperature for a second beverage;
a second door providing access to and egress from the second compartment;
a second a tap tower supported on the counter top and in communication with the second compartment;
at least a second bulk beverage keg containers stored within the second temperature controlled compartment and in operative communication with the second tap tower;
said second tap tower comprising at least one individually operable second touchless tap for and in operational communication with the second automated beverage dispensing system for an automated and controlled dispensing of a metered volume of beverage from the second bulk beverage keg.

5. The portable beverage service and dispensing cart for the automated and controlled delivery of beer and/or wine of claim 4, further comprising a second beverage control system within said second compartment for controlling communication of the second beverage to the second touchless tap supplied under pressure from within the second keg.

6. The portable beverage service and dispensing cart for the automated and controlled delivery of beer and/or wine of claim 4, further comprising a second temperature controller for independently controlling the second compartment, wherein the first compartment and second compartment are arranged lateral to one another.

7. The portable beverage service and dispensing cart for the automated and controlled delivery of beer and/or wine of claim 5, further comprising a second temperature controller for independently controlling the second compartment, wherein the first compartment and second compartment are arranged adjacently lateral to one another.

8. A method for enabling the use of keg beverages in a venue in a portable manner comprising:
providing a portable, relocatable, self operating portable beverage service and dispensing cart of claim 1;
deployed the portable, relocatable, self operating portable beverage service and dispensing cart for the automated and controlled delivery of beer and/or wine in a venue;
dispensing from the keg beverages in a controlled manner through the touchless tap in a remote, automated, controlled and recorded manner;
monitoring dispensing of beer and/or wine;
documenting and reporting said monitoring to a remote display system; and
retiring the portable, relocatable, self operating portable beverage service and dispensing cart of claim 1 for recharging the battery in preparation for subsequent use.

9. A method for enabling the use of keg beverages in a venue in a portable manner comprising:
providing a portable, relocatable, self operating portable beverage service and dispensing cart of claim 2;
deployed the portable, relocatable, self operating portable beverage service and dispensing cart for the automated and controlled delivery of beer and/or wine in a venue;
dispensing from the keg beverages in a controlled manner through the touchless tap in a remote, automated, controlled and recorded manner;
monitoring dispensing of beer and/or wine;
documenting and reporting said monitoring to a remote display system; and
retiring the portable, relocatable, self operating portable beverage service and dispensing cart for the automated and controlled delivery of beer and/or wine of claim 2 for recharging the battery in preparation for subsequent use.

10. A method for enabling the use of keg beverages in a venue in a portable manner comprising:
providing a portable, relocatable, self operating portable beverage service and dispensing cart of claim 3;
deployed the portable, relocatable, self operating portable beverage service and dispensing cart for the automated and controlled delivery of beer and/or wine in a venue;
dispensing from the keg beverages in a controlled manner through the touchless tap in a remote, automated, controlled and recorded manner;
monitoring dispensing of beer and/or wine;
documenting and reporting said monitoring to a remote display system; and
retiring the portable, relocatable, self operating portable beverage service and dispensing cart claim 3 for recharging the battery in preparation for subsequent use.

11. A method for enabling the use of keg beverages in a venue in a portable manner comprising:
providing a portable, relocatable, self operating portable beverage service and dispensing cart of claim 4;
deployed the portable, relocatable, self operating portable beverage service and dispensing cart for the automated and controlled delivery of beer and/or wine in a venue;
dispensing from the keg beverages in a controlled manner through the touchless tap in a remote, automated, controlled and recorded manner;
monitoring dispensing of beer and/or wine;
documenting and reporting said monitoring to a remote display system; and
retiring the portable, relocatable, self operating portable beverage service and dispensing cart for the automated and controlled delivery of beer and/or wine of claim 4 for recharging the battery in preparation for subsequent use.

12. A method for enabling the use of keg beverages in a venue in a portable manner comprising:
providing a portable, relocatable, self operating portable beverage service and dispensing cart of claim 6;
deployed the portable, relocatable, self operating portable beverage service and dispensing cart for the automated and controlled delivery of beer and/or wine in a venue;
dispensing from the keg beverages in a controlled manner through the touchless tap in a remote, automated, controlled and recorded manner;
monitoring dispensing of beer and/or wine;
documenting and reporting said monitoring to a remote display system; and
retiring the portable, relocatable, self operating portable beverage service and dispensing cart for the automated and controlled delivery of beer and/or wine of claim 5 for recharging the battery in preparation for subsequent use.

13. A method for enabling the use of keg beverages in a venue in a portable manner comprising:
providing a portable, relocatable, self operating portable beverage service and dispensing cart of claim 6;
deployed the portable, relocatable, self operating portable beverage service and dispensing cart for the automated and controlled delivery of beer and/or wine in a venue;
dispensing from the keg beverages in a controlled manner through the touchless tap in a remote, automated, controlled and recorded manner;
monitoring dispensing of beer and/or wine;
documenting and reporting said monitoring to a remote display system; and
retiring the portable, relocatable, self operating portable beverage service and dispensing cart of claim 6 for recharging the battery in preparation for subsequent use.

14. A method for enabling the use of keg beverages in a venue in a portable manner comprising:
providing a portable, relocatable, self operating portable beverage service and dispensing cart of claim 7;
deployed the portable, relocatable, self operating portable beverage service and dispensing cart for the automated and controlled delivery of beer and/or wine in a venue;
dispensing from the keg beverages in a controlled manner through the touchless tap in a remote, automated, controlled and recorded manner;
monitoring dispensing of beer and/or wine;
documenting and reporting said monitoring to a remote display system; and
retiring the portable, relocatable, self operating portable beverage service and dispensing cart for the automated and controlled delivery of beer and/or wine of claim 7 for recharging the battery in preparation for subsequent use.
